(19) United States
(12) Patent Application Publication
(10) Pub. No.: US 2011/0215542 A1
(43) Pub. Date: Sep. 8, 2011

(54) Folding Golf Cart

(76) Inventor: Jonathan Hwan Wang, Fremont, CA (US)

(21) Appl. No.: 13/107,869

(22) Filed: May 13, 2011

Related U.S. Application Data
(63) Continuation-in-part of application No. 12/789,840, filed on May 28, 2010.

(30) Foreign Application Priority Data
Sep. 29, 2009 (CN) 200920236562.0

(51) Int. Cl. B62B 3/10; B62B 5/04

(52) U.S. Cl. 280/35; 280/652

(57) ABSTRACT

An apparatus comprises a chassis comprising a front portion and a rear portion. A main member is joined to the chassis between the front portion and the rear portion for rotation in a generally vertical plane. A folding member is joined to the rear portion of the chassis for rotation in a generally vertical plane. A handle is joined to a top end of the folding member. A connector member is joined to the bottom end of the handle and joined to the main member. A locking device comprises a first portion and a second portion. The first portion is joined to the connector member. The second portion is joined to the main member where a rotation of the handle in a first direction mates the first portion to the second portion, and a rotation of the handle in a second direction folds the apparatus down to the chassis.

### CROSS-REFERENCE TO RELATED APPLICATIONS

The present continuation-in-part patent application claims priority benefit under 35 U.S.C. 120 of the U.S. nonprovisional patent Ser. No. 12/789,840, filed May 28, 2010 and titled “Qwik Fold Golf Push/Pull Cart” which in turn claims priority to Chinese patent application number 200920236562.0 filed Sep. 29, 2009, which is hereby incorporated by reference for all purposes to the extent that such subject matter is not inconsistent herewith or limiting hereof.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to golf equipment. More particularly, the invention relates to a folding cart for transporting a golf bag.

### BACKGROUND OF THE INVENTION

Many golfers use a wheeled cart to carry their golf clubs around the golf course. The primary requirement for these carts is that they have a large enough framework to facilitate different sizes of golf bags. Usually on a golf bag cart, upper and lower brackets on the cart support the top and bottom of the golf bag. There must be enough space between the brackets in order to hold the golf bag. However, this makes storage and transport of the cart difficult. Existing carts typically comprise a chassis, a main bar, and a push handle, which are all welded together and cannot be adjusted or moved. This makes it hard for manufacturers to reduce the size of the golf cart during transportation and storage, and as a result, manufacturers must use more containers, more space, or more box storage in order to store the carts and increased transportation and storage cost. Furthermore, for users, when not in use, these carts take up a great deal of space, resulting in inconvenience of storage and difficulty in transport.

In view of the foregoing, there is a need for improved techniques for providing a cart for golf bags that can be folded for easier storage and transport.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A, 1B and 1C illustrate an exemplary wheeled cart for transporting golf bags, in accordance with an embodiment of the present invention. FIG. 1A is a diagrammatic side view of the cart in an open position. FIG. 1B is a side perspective view of the cart in a folded position, and FIG. 1C is a side perspective view of the cart in a partially folded position;

FIG. 2 is a cross sectional view of an exemplary locking device from a golf bag cart, in accordance with an embodiment of the present invention; and

FIG. 3 illustrates an exemplary four wheeled version of the cart illustrated in FIG. 1C, in accordance with an embodiment of the present invention.

Unless otherwise indicated illustrations in the figures are not necessarily drawn to scale.

### SUMMARY OF THE INVENTION

To achieve the forgoing and other objects and in accordance with the purpose of the invention, a variety of folding golf cart techniques is described.

In one embodiment an apparatus comprises a chassis comprising a front portion and a rear portion. A main member comprises a top end and a bottom end. The bottom end of the main member being rotatably joined to the chassis between the front portion and the rear portion for rotation of the main member in a generally vertical plane. A folding member comprises a top end and a bottom end. The bottom end of the folding member being rotatably joined to the rear portion of the chassis for rotation of the folding member in a generally vertical plane. A handle comprises a bottom end. The bottom end being rotatably joined to the top end of the folding member. A connector member comprises a first end and a second end. The first end being fixedly joined to the bottom end of the handle. The second end being rotatably joined to the main member. A locking device comprises a first portion and a second portion. The first portion being fixedly joined to the first end of the connector member. The second portion being fixedly joined to the top end of the main member where a rotation of the handle in a first direction mates the first portion to the second portion to secure the locking device, and a rotation of the handle in a second direction folds the main member, the folding member, and the handle down to the chassis. In another embodiment the first portion of the locking device comprises a hook member. In yet another embodiment the second portion of the locking device comprises a button mechanism for engaging the hook member. In still another embodiment the second portion of the locking device further comprises a housing comprising a first opening being configured for accepting the hook member into the housing and a second opening. The button mechanism further comprises a top portion and a hook engaging member. The button mechanism being slidably mounted within the housing and being configured to protrude the top portion through the second opening and to position the hook engaging member to engage the hook member. A spring mechanism is operable for urging the top portion through the second opening and for engaging an inserted hook member with the hook engaging member where a force applied to the top portion, in opposition to the urging, slides the button mechanism for disengaging an inserted hook member. Another embodiment further comprises a front wheel assembly joined to the front portion of the chassis. In yet another embodiment the front wheel assembly comprises at least one wheel. Still another embodiment further comprises a rear wheel assembly. In another embodiment the rear wheel assembly is slidably joined to the main member and pivotally joined to the chassis. In yet another embodiment the rear wheel assembly further comprises a brake. Still another embodiment further comprises an upper bracket joined to an upper portion of the main member, the upper bracket being configured to secure a top portion of a golf bag. Another embodiment further comprises a lower bracket joined to the front portion of the chassis, the lower bracket being configured to secure a bottom portion of a golf bag. In yet another embodiment the chassis comprises an open frame construction. In still another embodiment the handle further comprises a sheath for increased friction and comfort during use.

In another embodiment an apparatus comprises a chassis comprising a front portion and a rear portion, a main structural support means being rotatably joined to the chassis between the front portion and the rear portion for rotation in a generally vertical plane, a folding means being rotatably joined to the rear portion of the chassis for rotation in a generally vertical plane, a handle being rotatably joined to the folding means, means for fixedly joining to the handle and rotatably joining to the main structural support means, a front wheel assembly joined to the front portion of the chassis, a rear wheel assembly, and means for locking the handle to the main structural support means where a rotation of the handle in a first direction secures the locking means, and a rotation of the handle in a second direction folds the main structural support means, the folding means, and the handle down to the chassis.

In another embodiment an apparatus comprises a chassis comprising a front portion and a rear portion. A main member comprises a top end and a bottom end. The bottom end of the main member being rotatably joined to the chassis between the front portion and the rear portion for rotation of the main member in a generally vertical plane. A folding member comprises a top end and a bottom end. The bottom end of the folding member being rotatably joined to the rear portion of the chassis for rotation of the folding member in a generally vertical plane. A handle comprises a bottom end. The bottom end being rotatably joined to the top end of the folding member. A connector member comprises a first end and a second end. The first end being fixedly joined to the bottom end of the handle. The second end being rotatably joined to the main member. A front wheel assembly is joined to the front portion of the chassis. A rear wheel assembly is joined. A locking device comprises a first portion and a second portion. The first portion comprises a hook member. The first portion being fixedly joined to the first end of the connector member. The second portion comprises a button mechanism for engaging the hook member. The second portion being fixedly joined to the top end of the main member where a rotation of the handle in a first direction mates the first portion to the second portion to secure the locking device, and a rotation of the handle in a second direction folds the main member, the folding member, and the handle down to the chassis. In another embodiment the rear wheel assembly is slidably joined to the main member and pivotally joined to the chassis. In yet another embodiment the rear wheel assembly further comprises a brake. Still another embodiment further comprises an upper bracket joined to an upper portion of the main member. The upper bracket being configured to secure a top portion of a golf bag. Another embodiment further comprises a lower bracket joined to the front portion of the chassis. The lower bracket being configured to secure a bottom portion of a golf bag. In yet another embodiment the chassis comprises an open frame construction.

Other features, advantages, and objects of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

A preferred embodiment of the present invention and at least one variation thereof provide a folding cart for carrying a golf bag that is easy to fold, transport and operate and saves storage space. Many preferred embodiments comprise a chassis, a main bar, a push handle, a folding bar, and a connector bar. In these preferred embodiments, the main bar, connector bar, folding bar, and chassis together form a telescopic four-bar linkage, the action of which moves other components involved in the action accordingly to fold or unfold the cart.

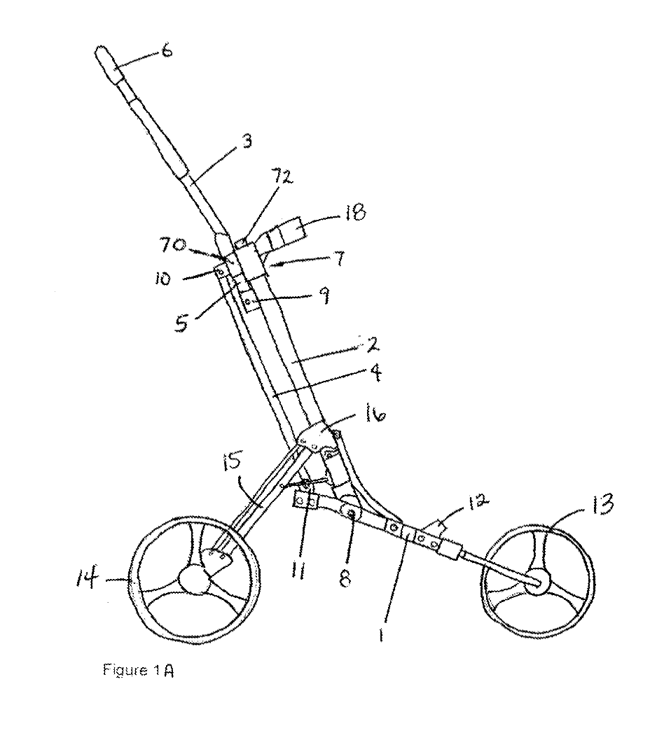

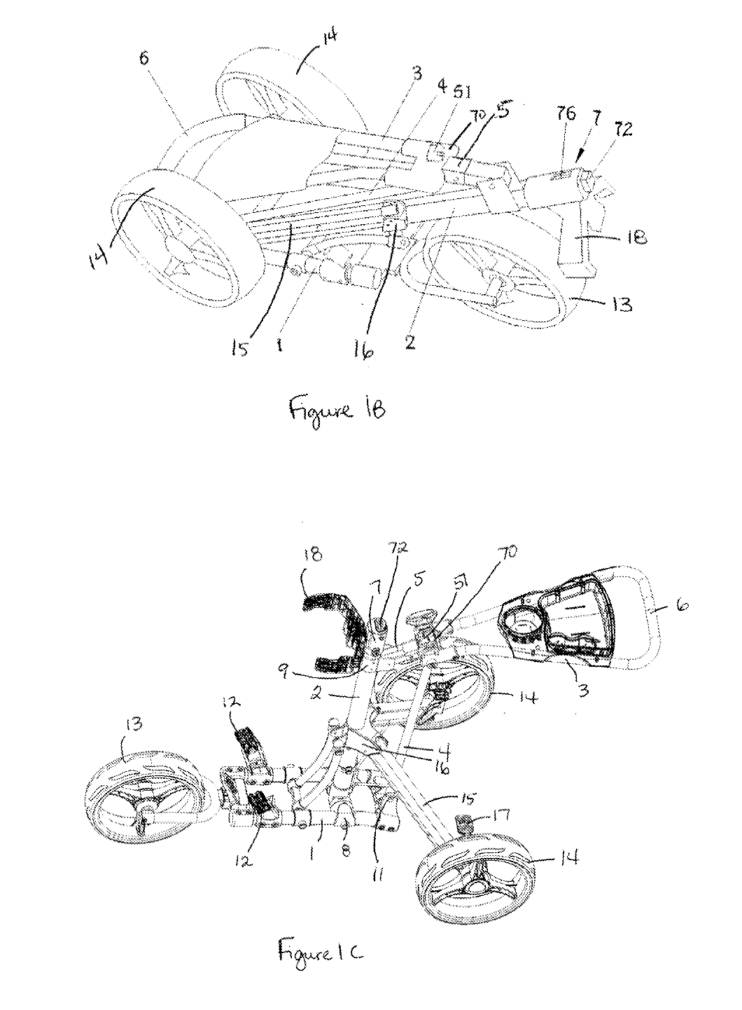

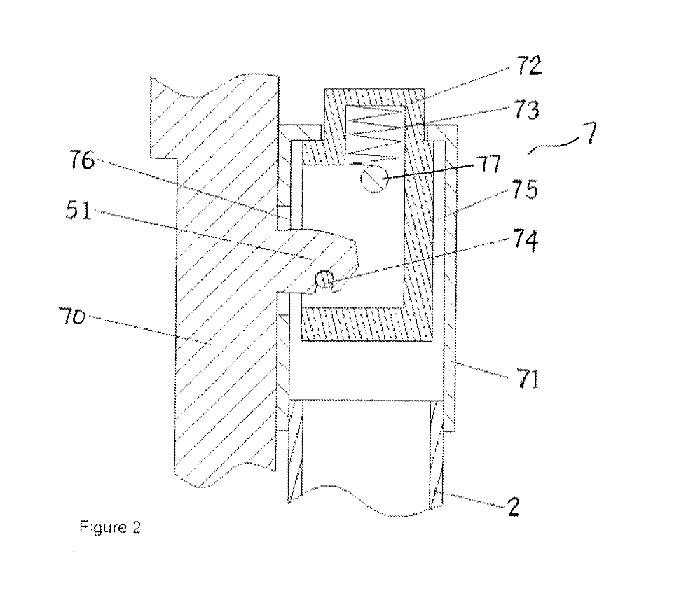

FIGS. 1A, 1B and 1C illustrate an exemplary wheeled cart for transporting golf bags, in accordance with an embodiment of the present invention. FIG. 1A is a diagrammatic side view of the cart in an open position. FIG. 1B is a side perspective view of the cart in a folded position, and FIG. 1C is a side perspective view of the cart in a partially folded position. In the present embodiment, the folding golf bag cart comprises a chassis 1, a main bar 2, a push handle 3, and a folding bar 4. The bottom of main bar 2 connects to chassis 1 with a rotating joint 8. The bottom of push handle 3 attaches to a connector bar 5 with a fixed connection such as, but not limited to, a welded connection or a bolted connection; however, in alternate embodiments this connection may be hinged to allow for more folding configurations. In the present embodiment, one end of connector bar 5 connects near the top of main bar 2 with a hinge 9, and the other end of connector bar 5 connects to folding bar 4 with a hinge 10. The end of folding bar 4 opposite of hinge 10 connects to chassis 1 with a rotating joint 11. Main bar 2, connector bar 5, folding bar 4, and chassis 1 form a telescopic four-bar linkage, and the movement of main bar 2, connector bar 5, folding bar 4, and chassis 1 together can trigger the movement of the entire golf cart. The four-bar linkage is a parallel linkage, with a stable structure and smooth movements. Towards the top of main bar 2 exists a locking device 7 to lock main bar 2 to connector bar 5. Locking device 7 is locked into place by a hook 51 on a connector 70 at the end of connector bar 5. Hook 51 is inserted into an opening 76 in locking device 7. A button 72 releases locking device 7 from connector 70, as illustrated by way of example in FIG. 2. Referring to FIG. 1A, when connector bar 5 is locked by locking device 7, the cart is fixed in the open position. Referring to FIG. 1B, when connector bar 5 is unlocked, the movement of connector bar 5 triggers the movement of main bar 2, push bar 3 and folding bar 4 accordingly to collapse the cart into the folded position.

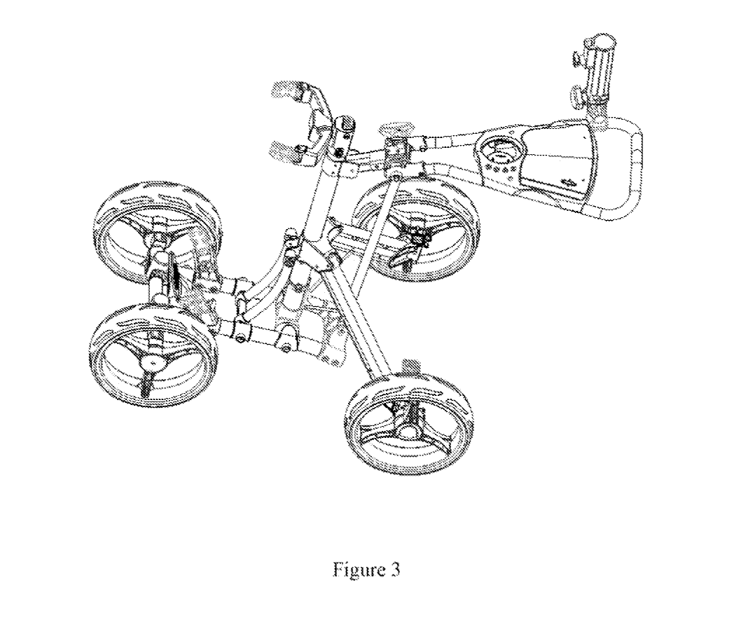

In the present embodiment chassis 1 is a rigid structure comprising a lower bracket 12 and a front wheel 13. Those skilled in the art, in light of the teachings of the present invention, will readily recognize that the shape of the chassis in alternate embodiments may vary widely depending on various factors such as, but not limited to, the size of the golf bag being carried, the size of the cart, aesthetics, etc. For example, without limitation, some alternate embodiments may comprise a round chassis to accommodate the rounded bottom of many golf bags. Other alternate embodiments may comprise a solid chassis rather than a chassis with an open frame. In the present embodiment, two rear wheels 14 are attached to main bar 2 through wheel supports 15 connected to a sliding hinge 16. Sliding hinge 16 enables wheel supports 15 to move in relation to the four-bar linkage while the cart is being folded or unfolded. In alternate embodiments the rear wheels may be attached directly to the chassis. In other alternate embodiments the cart may comprise more wheels. For example, without limitation, one such embodiment comprises four wheels as shown in FIG. 3. It is contemplated that alternate embodiments may use various different types of wheels such as, but not limited to, narrow bicycle-type wheels, rugged all-terrain wheels, hard plastic or metal wheels, etc. Referring to FIG. 1C, in the present embodiment, a brake 17 on one of rear wheels 14 enables rear wheel 14 to be locked to generally prevent the cart from rolling; however, this brake may be replaced by various different types of stopping means in some alternate embodiments such as, but not limited to, kick stands; other alternate embodiments may be implemented with no stopping means.

In the present embodiment an upper bracket 18 on main bar 2 holds the top portion of a golf bag. Those skilled in the art, in light of the teachings of the present embodiment, will readily recognize that a multiplicity of suitable brackets varying in size, shape and type may be used in alternate embodiments for the upper and lower brackets in order to accommodate a variety of golf bags. Furthermore, some alternate embodiments may use attachment means other than brackets such as, but not limited to, straps, clips, cages, bolts, etc. In the present embodiment push handle 3 is triangular in shape and has a protective sheath 6 made of a pliable material such as, but not limited to, rubber to increase the friction between fingers and to make push handle 3 more comfortable to use. Alternate embodiments may be implemented without this protective sheath. Furthermore, it is contemplated that a multiplicity of suitable types of push handles may be used in alternate embodiments. For example, without limitation, a push handle comprising a single L-shaped bar may be used in one alternate embodiment. Another alternate embodiment may comprise two single-bar push handles in a V formation. Other exemplary shapes for push handles that are suitable for alternate embodiments include without limitation, T shapes, U shapes, rectangular shapes, etc.

FIG. 2 is a cross sectional view of an exemplary locking device 7 from a golf bag cart, in accordance with an embodiment of the present invention. In the present embodiment, the top of a main bar 2 connects to a connector 70 for locking device 7. Locking device 7 comprises a housing 71, a button 72, a reset spring 73, and a card column 74. Housing 71 is configured with an internal cavity 75 to accommodate button 72 so that the top of button 72 pierces out of housing 71. The top of reset spring 73 sits between a stopper 77 in internal cavity 75 and button 72. Card column 74 is fixed to button 72. Housing 71 comprises an opening 76 near card column 74. Connector 70 is equipped with a hook 51, which corresponds to opening 76 in housing 71 when the cart is in the open position and can be inserted into internal cavity 75 to hook onto card column 74. Latching hook 51 onto card column 74 locks the four-bar linkage to hold the cart in the open position. When the cart needs to be folded, button 72 is pressed to release hook 51 from card column 74 and release connector 70 from locking device 7. Reset spring 73 returns button 72 to its original position once button 72 is released.

FIG. 3 illustrates an exemplary four wheeled version of the cart illustrated in FIG. 1C, in accordance with an embodiment of the present invention. Those skilled in the art will readily recognize a multiplicity of suitable multi-wheeled designs in accordance with the teachings of the present invention. By way of example, without limitation, a four wheeled design is contemplated as exemplified in FIG. 3.

Referring to FIGS. 1A, 1B and 1C, in typical use of the present embodiment, to fold the cart, a user pushes button 72 to unlock connector 70 from locking device 7. Then, the user pushes push handle 3 downward. With this motion, connection bar 5 rotates from a parallel position with respect to main bar 2 and folding bar 4 to a position that is perpendicular to these bars. This drives the tops of main bar 2 and folding bar 4 forward while rotating about rotating joints 8 and 11 and makes the cart form a Z shape, as shown by way of example in FIG. 1C. As main bar 2 moves forward, sliding hinge 16 slides up main bar 2, which reduces the angle between main bar 2 and wheel supports 15 and pulls rear wheels 14 in toward chassis 1. Referring to FIG. 1B, as the user continues to push downward and forward on push bar 3, connection bar 5 continues to rotate until it is almost parallel with folding bar 4 and the cart is fully collapsed. In this closed position, the frame is in a compressed Z shape with push handle 3 between rear wheels 14, which are close to chassis 1, and main bar 2 over front wheel 13. Collapsing the cart substantially reduces the size of the cart and saves space so the cart is more convenient to store and transport.

To open the cart, the user reverses this action by pulling up on push handle 3. This rotates connection bar 5 back into the perpendicular position with main bar 2 and folding bar 4 and then the parallel position while rotating main bar 2 and folding bar 4 about rotating joints 8 and 11 up into an upright position. Sliding hinge 16 slides back down main bar 2 to extend wheel supports 15 and rear wheels 14 back and away from chassis 1. Referring to FIG. 1A, once the cart is upright, the user snaps connector 70 into place in locking device 7 to lock the cart in the open position. The user may now attach the top of a golf bag to upper bracket 18 and the bottom of the golf bag to lower bracket 12 and transport the golf bag easily. In the present embodiment, the cart has a simple structure that is easy to fold or unfold with one action. The cart is also easy and convenient to use.

Those skilled in the art, in light of the teachings of the present invention, will readily recognize that alternate embodiments of the present invention may be implemented with various different elements, configurations and features. For example, without limitation, some alternate embodiments may include a lock or locks to hold the cart in the folded position. Some alternate embodiments may also include handles for carrying the cart when in the folded position. Another alternate embodiment may be configured with two front wheels and a single rear wheel. Yet other alternate embodiments may include some components that are removable, for example, without limitation, the push handle or the wheels. Yet other alternate embodiments may be implemented with a variety of accessories such as, but not limited to, drink holders, writing platforms, small storage bins, lights, speakers, radios, music player docks, etc.

Having fully described at least one embodiment of the present invention, other equivalent or alternative methods of providing a folding cart according to the present invention will be apparent to those skilled in the art. The invention has been described above by way of illustration, and the specific embodiments disclosed are not intended to limit the invention to the particular forms disclosed. For example, the particular implementation of the cart may vary depending upon the particular type of application for which it is to be used. The carts described in the foregoing were directed to golfing implementations; however, similar techniques are to provide folding carts for transporting various different items such as, but not limited to, other types of sports equipment, gardening tools, camping gear, etc. Non-golfing implementations of the present invention are contemplated as within the scope of the present invention. The invention is thus to cover all modifications, equivalents, and alternatives falling within the spirit and scope of the following claims.

What is claimed is:

1. An apparatus comprising:
a chassis comprising a front portion and a rear portion;
a main member comprising a top end and a bottom end, said bottom end of said main member being rotatably joined to said chassis between said front portion and said rear portion for rotation of said main member in a generally vertical plane;
a folding member comprising a top end and a bottom end, said bottom end of said folding member being rotatably joined to said rear portion of said chassis for rotation of said folding member in a generally vertical plane;
a handle comprising a bottom end, said bottom end being rotatably joined to said top end of said folding member;
a connector member comprising a first end and a second end, said first end being fixedly joined to said bottom end of said handle, said second end being rotatably joined to said main member; and
a locking device comprising a first portion and a second portion, said first portion being fixedly joined to said first end of said connector member, said second portion being fixedly joined to said top end of said main member where a rotation of said handle in a first direction mates said first portion to said second portion to secure said locking device, and a rotation of said handle in a second direction folds said main member, said folding member, and said handle down to said chassis.

2. The apparatus as recited in claim 1, in which said first portion of said locking device comprises a hook member.

3. The apparatus as recited in claim 2, in which said second portion of said locking device comprises a button mechanism for engaging said hook member.

4. The apparatus as recited in claim 3, in which said second portion of said locking device further comprises:
a housing comprising a first opening being configured for accepting said hook member into said housing and a second opening;
said button mechanism further comprising a top portion and a hook engaging member, said button mechanism being slidably mounted within said housing and being configured to protrude said top portion through said second opening and to position said hook engaging member to engage said hook member; and
a spring mechanism being operable for urging said top portion through said second opening and for engaging an inserted hook member with said hook engaging member where a force applied to said top portion, in opposition to said urging, slides said button mechanism for disengaging an inserted hook member.

5. The apparatus as recited in claim 1, further comprising a front wheel assembly joined to said front portion of said chassis.

6. The apparatus as recited in claim 5, in which said front wheel assembly comprises at least one wheel.

7. The apparatus as recited in claim 1, further comprising a rear wheel assembly.

8. The apparatus as recited in claim 7, in which said rear wheel assembly is slidably joined to said main member and pivotally joined to said chassis.

9. The apparatus as recited in claim 7, in which said rear wheel assembly further comprises a brake.

10. The apparatus as recited in claim 1, further comprising an upper bracket joined to an upper portion of said main member, said upper bracket being configured to secure a top portion of a golf bag.

11. The apparatus as recited in claim 10, further comprising a lower bracket joined to said front portion of said chassis, said lower bracket being configured to secure a bottom portion of a golf bag.

12. The apparatus as recited in claim 1, in which said chassis comprises an open frame construction.

13. The apparatus as recited in claim 1, in which said handle further comprises a sheath for increased friction and comfort during use.

14. An apparatus comprising:
a chassis comprising a front portion and a rear portion;
a main structural support means being rotatably joined to said chassis between said front portion and said rear portion for rotation in a generally vertical plane;
a folding means being rotatably joined to said rear portion of said chassis for rotation in a generally vertical plane;
a handle being rotatably joined to said folding means;
means for fixedly joining to said handle and rotatably joining to said main structural support means;
a front wheel assembly being joined to said front portion of said chassis;
a rear wheel assembly; and
means for locking said handle to said main structural support means where a rotation of said handle in a first direction secures said locking means, and a rotation of said handle in a second direction folds said main structural support means, said folding means, and said handle down to said chassis.

15. An apparatus comprising:
a chassis comprising a front portion and a rear portion;
a main member comprising a top end and a bottom end, said bottom end of said main member being rotatably joined to said chassis between said front portion and said rear portion for rotation of said main member in a generally vertical plane;
a folding member comprising a top end and a bottom end, said bottom end of said folding member being rotatably joined to said rear portion of said chassis for rotation of said folding member in a generally vertical plane;
a handle comprising a bottom end, said bottom end being rotatably joined to said top end of said folding member;
a connector member comprising a first end and a second end, said first end being fixedly joined to said bottom end of said handle, said second end being rotatably joined to said main member;
a front wheel assembly joined to said front portion of said chassis;
a rear wheel assembly; and
a locking device comprising a first portion and a second portion, said first portion comprising a hook member, said first portion being fixedly joined to said first end of said connector member, said second portion comprising a button mechanism for engaging said hook member, said second portion being fixedly joined to said top end of said main member where a rotation of said handle in a first direction mates said first portion to said second portion to secure said locking device, and a rotation of said handle in a second direction folds said main member, said folding member, and said handle down to said chassis.

16. The apparatus as recited in claim 15, in which said rear wheel assembly is slidably joined to said main member and pivotally joined to said chassis.

17. The apparatus as recited in claim 15, in which said rear wheel assembly further comprises a brake.

18. The apparatus as recited in claim 15, further comprising an upper bracket joined to an upper portion of said main member, said upper bracket being configured to secure a top portion of a golf bag.

19. The apparatus as recited in claim 18, further comprising a lower bracket joined to said front portion of said chassis, said lower bracket being configured to secure a bottom portion of a golf bag.

20. The apparatus as recited in claim 15, in which said chassis comprises an open frame construction.
